(19) United States
(12) Patent Application Publication
(10) Pub. No.: US 2016/0314247 A1
(43) Pub. Date: Oct. 27, 2016

(54) MEDICAL IMAGE DISPLAYING DEVICE AND A NON-TRANSITORY COMPUTER-READABLE RECORDING MEDIUM

(71) Applicant: KONICA MINOLTA, INC., Tokyo (JP)

(72) Inventors: Kenji NAGAO, Tokorozawa-shi (JP); Takafumi NANJO, Tokyo (JP)

(73) Assignee: KONICA MINOLTA, INC., Tokyo (JP)

(21) Appl. No.: 15/130,708

(22) Filed: Apr. 15, 2016

(30) Foreign Application Priority Data
Apr. 27, 2015 (JP) 2015-089976

(51) Int. Cl. G06F 19/00; G06T 11/60; G06F 17/24; G06T 7/00

(52) U.S. Cl. CPC G06F 19/321; G06T 7/0016; G06T 11/60; G06F 17/241; G06T 2207/30004; G06T 2207/10081; G06T 2207/10088

(57) ABSTRACT

A medical image displaying device includes an operation unit, a display, an acquirer, a temporal displaying controller and a recorder. The display displays a medical image of an object obtained by capturing the object. The acquirer acquires past lesion information on the object found in a past image of the object and recorded in connection with the past image. The temporal displaying controller to temporarily overlay the past lesion information acquired by the acquirer on the medical image. The recorder records the lesion information on the medical image without modification in response to a prescribed instruction from the operation unit to record the lesion information temporarily overlaid on the medical image without modification, and edits the lesion information to record as the lesion information on the medical image in response to another prescribed instruction from the operation unit to edit the lesion information.

### CROSS REFERENCE TO RELATED APPLICATION

The present U.S. application claims a priority under the Paris Convention of Japanese Patent Application No. 2015-089976 filed on Apr. 27, 2015, the entirety of which is incorporated herein by reference.

### BACKGROUND OF THE INVENTION

1. Field of the Invention

The present invention relates to a medical image displaying device and a non-transitory computer-readable recording medium.

2. Description of Related Art

In follow-up of lesions, geometric and dimensional changes in one lesion are generally tracked with a current image and past images, and progression or recovery of a disease is thereby diagnosed. In detail, comparison of the geometries and sizes of the lesions between the current image and the past images requires to identify the site of a lesion in each image, to specify the measuring points of the lesion to determine the size of the lesion, and to record the lesion tagged with the lesion name (lesion number). In a long-period follow-up involving a large number of comparative past images or in one examination including a large number of lesions, the measurement of the lesions may be more difficult with much more labor for recording of the lesions.

Japanese Patent Laid-Open Publication No. 2009-72433, for example, describes a method of automatically measuring the major axes and the minor axes of lesion regions in the current image and the past images at the same site and in the same direction, in response to designation of the site of a lesion on either one of the current image or the past images by a user.

The method described in Japanese Patent Laid-Open Publication No. 2009-72433, however, presumes that the lesions are identical in number and have minor positional and dimensional changes between the past images and the current image. The method is unsuitable for complicated variations in lesions between the current and past images, for example, scattered multiple lesions, positional and dimensional changes in a lesion, fusion of multiple lesions, or separation or disappearance of one lesion.

An object of the present invention is to make it possible to record complicated changes in a lesion through a simple operation.

### SUMMARY OF THE INVENTION

To solve the object described above, according to one aspect of the present invention, there is provided a medical image displaying device including: an operation unit; a display to display a medical image of an object obtained by capturing the object; an acquirer to acquire past lesion information on the object, the past lesion information being found in a past image of the object and being recorded in connection with the past image, the past image being obtained by capturing the object before acquiring the medical image; a temporal displaying controller to temporarily overlay the past lesion information acquired by the acquirer on the medical image; and a recorder, wherein the recorder records the lesion information on the medical image without modification in response to a prescribed instruction from the operation unit to record the lesion information temporarily overlaid on the medical image without modification, and the recorder edits the lesion information to record as the lesion information corresponding to the medical image in response to another prescribed instruction from the operation unit to edit the lesion information.

According to another aspect of the present invention, there is provided a non-transitory recording medium having a computer-readable program thereon, the program making a computer function as: a display to display a medical image of an object obtained by capturing the object; an acquirer to acquire past lesion information on the object, the past lesion information being found in a past image of the object and being recorded in connection with the past image, the past image being obtained by capturing the object before acquiring the medical image; a temporal displaying controller to temporarily overlay the past lesion information acquired by the acquirer on the medical image; and a recorder, wherein the recorder records the lesion information on the medical image without modification in response to a prescribed instruction from an operation unit to record the lesion information temporarily overlaid on the medical image without modification, and the recorder edits the lesion information to record as the lesion information corresponding to the medical image in response to another prescribed instruction from the operation unit to edit the lesion information.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 illustrates an entire configuration of a medical image displaying system according to the present embodiment;

FIG. 2 is a block diagram illustrating a functional configuration of a client terminal shown in FIG. 1;

FIG. 3 is a flow chart illustrating a process of registering lesion information performed by a controller shown in FIG. 2;

FIG. 4 illustrates exemplary lesion information on a past image;

FIG. 5A illustrates an exemplary current image on which the lesion information on the past image shown in FIG. 4 is temporarily overlaid;

FIG. 5B illustrates an exemplary current image on which the lesion information on the past image shown in FIG. 4 is temporarily overlaid;

FIG. 5C illustrates an exemplary current image on which the lesion information on the past image shown in FIG. 4 is temporarily overlaid;

FIG. 6A illustrates an example of a past image;

FIG. 6B illustrates a current image showing the fusion of the lesions shown in FIG. 6A and an exemplary merging operation to record this fusion;

FIG. 7A illustrates an example of a past image;

FIG. 7B illustrates a current image showing the separation of the lesion shown in FIG. 7A and an exemplary separation operation to record this separation;

FIG. 8A illustrates an example of a past image;

FIG. 8B illustrates a current image showing the disappearance of one of the lesions shown in FIG. 8A and an exemplary deleting operation to record this disappearance;

FIG. 9A illustrates an example of a past image;

FIG. 9B illustrates a current image on which the lesion information on the past image shown in FIG. 9A is tentatively overlaid; and

FIG. 9C illustrates an example current image after registration of the lesions.

### DESCRIPTION OF THE PREFERRED EMBODIMENTS

Preferred embodiments according to the present invention will now be described with reference to the attached drawings. It is noted that these examples shown in the drawings should not be construed to limit the present invention.

[Configuration of Medical Image Displaying System 100]

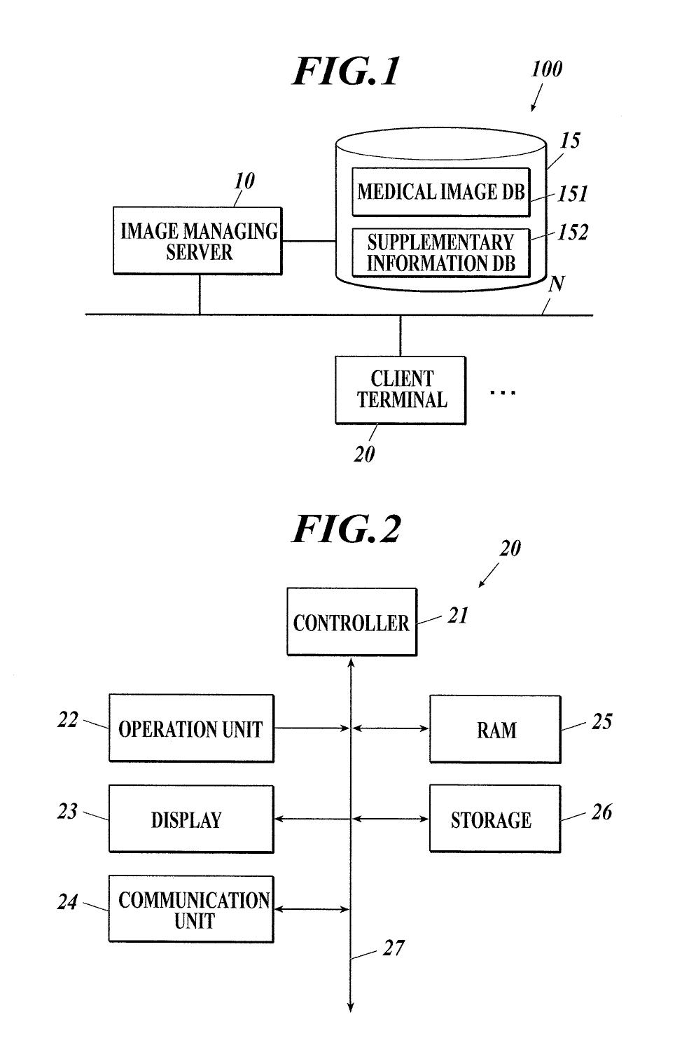

FIG. 1 illustrates an exemplary configuration of the medical image displaying system 100.

The medical image displaying system 100 is installed in a hospital. As shown in FIG. 1, the medical image displaying system 100 includes an image managing server 10, and a client terminal 20 as a medical image display device. These devices are connected each other via a communication network N including communication lines, such as a local area network (LAN) and a wide area network (WAN). All devices included in the medical image displaying system 100 comply with the digital image and communications in medicine (DICOM) standard and communicate with each other according to the standard. The system 100 may include two or more image managing severs 10 and client terminals 20.

The image managing server 10 is a computer system that stores and manages data and supplementary information on medical images generated by various types of modality, such as a computed tomographic (CT) device, a magnetic resonance imaging (MRI) device, and a computed radiographic (CR) device. The medical images include tomographic images generated by CT and MRI devices, and plain radiographs generated by CR devices. Specifically, the image managing server 10 has a storage 15 including a hard disk drive or the like. The storage 15 stores a medical image DB (Data Base) 151 to store the data of the medical images, and a supplementary information DB 152 to store retrievable supplementary information on the medical images in the medical image DB 151.

The medical images in the medical image DB 151 are in the DICOM file format that complies with the DICOM standard. The DICOM file has an image area and a header. The image area and the header store the actual data and the supplementary information on the medical image, respectively.

The supplementary information includes, for example, patient information, examination information, series information, and detailed image information.

The patient information includes patient identifying information (for example, a patient ID) for identifying a patient, and various types of information, such as a name, a sex, and a birth date of the patient.

The examination information includes examination identifying information (for example, examination ID) for identifying the examination, examination date, and various types of information on the examination, such as the name of a doctor in charge.

The series information includes various types of information on series such as series numbers for identifying the series having medical images in one examination, types of the modality used for generation of the medical images included in the series, examination regions, slice intervals in the case of tomographic medical images, and the total number of slices.

The term “series” herein refers to a group of consecutive medical images related to each other. For example, a CT device and an MRI device continuously capture images of a certain region of a human body (for example, from the chest to the abdomen) along the direction of the body axis (for example, from a head to a foot) at a predetermined slice interval (for example, 1 mm) multiple times, and thereby generate multiple (100 to several thousands of) tomographic images. This group of generated tomographic images is regarded as one series. All tomographic images included in the same series have the same series information. The total number of slices equals to the total number of tomographic images belonging to the same series.

The detailed image information includes various types of information on the image such as an image number, a slice position (position measured in the direction of the body axis from a reference point (0 mm) where the first tomographic image is captured in one series), an image generation time, a file path name showing a site storing the medical image, an examination comment and lesion information.

The image numbers 1 to n (n is the total number of slices) indicate the order of the medical images captured in the same series.

The lesion information includes identification information of a lesion found on the medical image, a measurement position when the size of the lesion is measured (a coordinate of the measurement position) and results of measurement (results of measurement of lengths of the major axis and the minor axis of the lesion). If the medical image includes plural lesions, the detailed image information includes a plurality of pieces of lesion information.

In response to a search requirement from the client terminal 20 through the communication network N, the image managing server 10 retrieves medical images satisfying a condition sent from the client terminal 20, with the supplementary information DB 152 as a search tag, and then sends the data list of the medical images satisfying the condition to the client terminal 20. In addition, the image managing server 10 reads the data of the medical image requested from the client terminal 20 from the medical image DB 151 and then sends the data to the client terminal 20.

[Configuration of Client Terminal 20]

The client terminal 20 is a computer system for acquiring and displaying a medical image stored in the image managing server 10 for interpretation by a medical doctor.

FIG. 2 illustrates a functional configuration of the client terminal 20.

As shown in FIG. 2, the client terminal 20 includes a controller 21, an operation unit 22, a display 23, a communication unit 24, a RAM 25, a storage 26, and a bus 27 connecting these units.

The controller 21 includes a central processing unit (CPU) and the like. The controller 21 loads various programs in a work area in the RAM 25. The programs include an operation system program and a lesion information registering process program stored in the storage 26. The controller 21 controls all units under instructions contained in the programs. The controller 21 functions as an acquirer, a temporal displaying controller and a recorder.

The operation unit 22 includes a keyboard and a pointing device, such as a mouse. The keyboard has cursor keys, numeric keys, and several functional keys. Instruction signals from the keyboard and the mouse are output to the controller 21.

The display 23 includes a display monitor, such as a liquid crystal display (LCD) and a cathode ray tube (CRT), which displays various menus and medical images according to display signals from the controller 21.

The communication unit 24 includes a LAN adapter, a router, and a terminal adapter (TA) and transfers data from or to all devices connected to the communication network N.

The RAM 25 defines a work area that temporarily stores various programs read from the storage 26, input and output data, and parameters before and during various processes performed by the controller 21.

The storage 26 includes a hard disk drive (HDD), a non-volatile semiconductor memory or the like.

The storage 26 stores various programs such as the lesion information registering process program to be executed in the controller 21 and the display controlling program, and data required for executing these programs. The programs are stored in the form of computer-readable codes in the storage 26. The controller 21 sequentially performs operations according to the program codes.

[Operation of Client Terminal 20]

An operation of the embodiment will now be described.

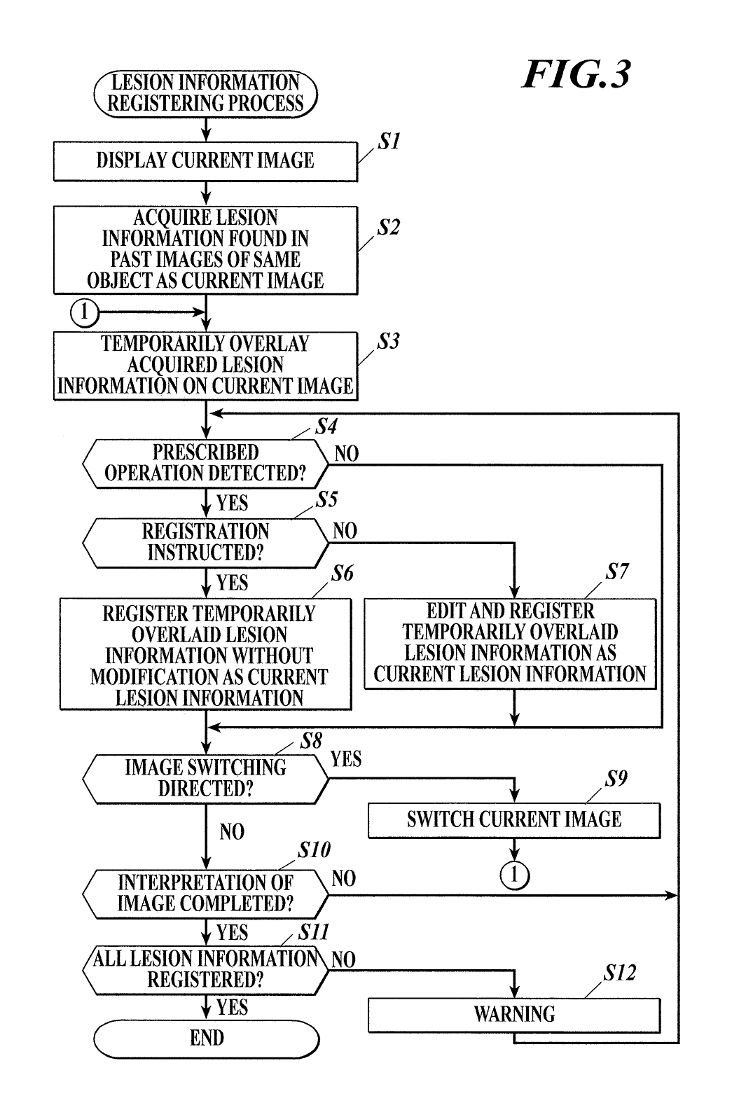

FIG. 3 illustrates a flow chart of a process of registering lesion information after the selection of a current examination to be subjected to a registration of lesion information by the operation unit 22 of the client terminal 20 and the acquisition of the medical image (referred to as a current image) of the current examination from the image managing server 10. The lesion information registering process is performed by software processing realized by the controller 21 and the lesion information registering process program stored in the storage 26.

The controller 21 displays the current image on the display 23 (Step S1). If the current examination involves multiple tomographic images captured by, for example, a CT device and/or an MRI device, one of the current images (for example, the image having the leading image number) is displayed.

The controller 21 then acquires lesion information found in a medical image captured in a past examination (referred to as a past image) from the image managing server 10 (Step S2). The lesion information and the past image are associated with each other and are stored in the image managing server 10. The past image of the lesion is a previously captured image of the same object under the same imaging conditions as those of the current image appearing on the display 23.

It can be determined whether the imaging conditions of the images are the same, on the basis of, for example, conformity in predetermined items of supplementary information written on the medical images. For example, the controller 21 reads the predetermined items (for example, patient information, series number, modality type, and examination region) from the supplementary information on the displayed current image, and acquires the lesion information on the medical image (or all images, if multiple images exist) of the past examination having supplementary information conforming with the read supplementary information, through a communication unit 24 from the image managing server 10.

The predetermined items described above for determining the imaging conditions can be established with the operation unit 22, and the information on the items are stored in the storage 26.

The controller 21 then temporarily overlays the acquired lesion information on the current image appearing on the display 23 (Step S3).

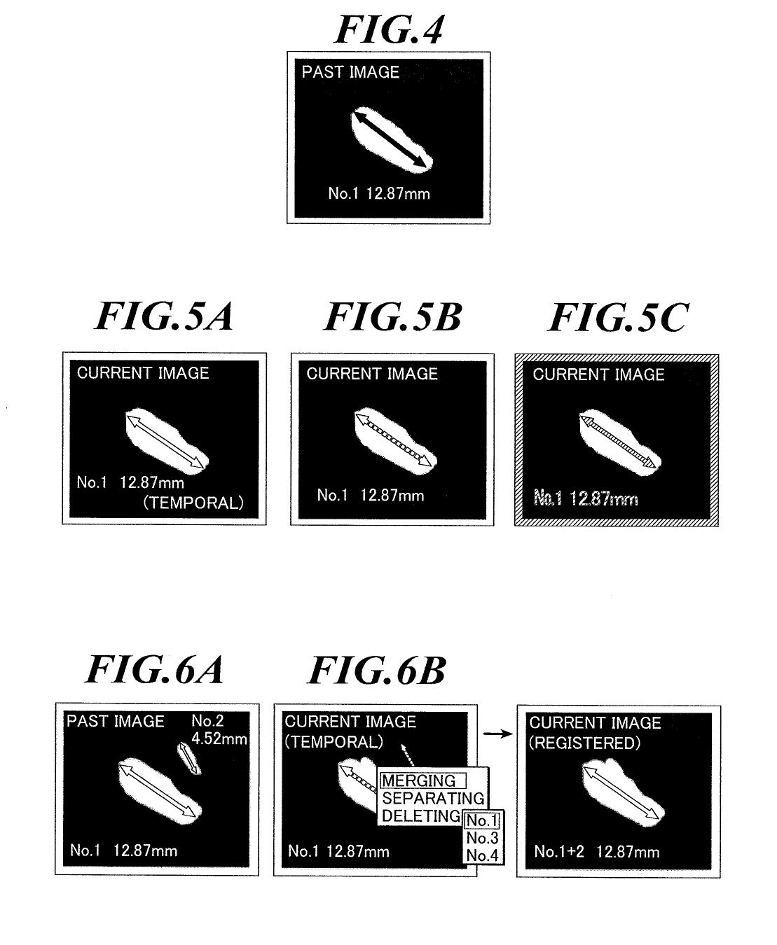

FIG. 4 illustrates exemplary lesion information on the past image. FIGS. 5A to 5C illustrate exemplary current images on which lesion information on the past image shown in FIG. 4 is temporarily overlaid. In Step S3, as shown in FIGS. 5A to 5C, an annotation indicating the measuring point of the lesion in the past image is temporarily overlaid on the current image. Identifying information on the lesion corresponding to the annotation and other parameters, such as size, of the lesion, are also temporarily overlaid in the vicinity of the annotation. In the embodiment, the lesion information is temporarily overlaid in a different manner from that of the registered lesion information on the current image, in order to clearly indicate that the lesion information overlaid on the current image is not registered lesion information on the current image but a temporal image. The temporal lesion information may be displayed in any manner; for example, the temporal lesion information may be displayed with the term “(temporal)”, as shown in FIG. 5A, the annotation thereof may be overlaid translucently and/or with dotted line, as shown in FIG. 5B, and/or the temporal lesion information and the image frame of the information may be displayed in a different color from that of the registered lesion information, as shown in FIG. 50.

In the embodiment, one piece of lesion information is stored (registered) in one lesion in general. For example, in the case of an examination involving capturing multiple tomographic images using a modality, for example, a CT device or an MRI device, the lesion information is registered in a tomographic image containing the largest lesion. The tomographic examination using modality such as a CT device and an MRI device, therefore, requires selection of a current image on which the temporal lesion information on the past image is to be overlaid.

If the current examination is a tomographic examination using a CT device or an MRI device, supplementary information on a sequence of past images of past examinations is acquired in Step S2 shown in FIG. 3. A current image having the same slice position or image number as that of the acquired supplementary information including the lesion information can then be selected as an image on which the lesion information is to be temporarily displayed. In consideration of a variation in position and site of the lesion over time, current images before and after the current image having completely the same slice position or image number may also be selected as images on which the lesion information are to be temporarily displayed. For example, current images within a predetermined range (for example, ±5 images) from the current image having the same slice position (image number) as the past image having the lesion information may be selected as images on which the lesion information are to be temporarily displayed.

Alternatively, a lesion region close to the measuring point of the past lesion information may be automatically extracted from each current image with a region extracting algorithm. From the images having the extracted lesion region, an appropriate image (for example, having the largest area of the lesion region) then may be selected as a current image on which the lesion information is to be temporarily displayed. Any known region extracting algorithm, such as a split and merge algorithm and a clustering algorithm (k-means algorithm), can be used.

The controller 21 then detects a specified instruction from the operation unit 22 (Step S4). The specified instruction triggers registration of the lesion information temporarily displayed. Examples of such a specified instruction include an instruction to register the lesion information temporarily overlaid without modifications on the current image appearing on the display 23 (for example, double-click on an annotation with a mouse of the operation unit 22), and an instruction to edit the lesion information temporarily overlaid (for example, dragging (to adjust the position) of an annotation with the mouse of the operation unit 22, dragging (to adjust the dimension) of the tip of an annotation, and merging, separation, and deletion of the lesion, described below).

If no specified instruction from the operation unit 22 is detected (Step S4; NO), the controller 21 shifts processing to Step S8.

If a specified instruction from the operation unit 22 is detect (Step S4; YES), the controller 21 determines whether the detected specified instruction instructs registration of the lesion information temporarily overlaid without modification (Step S5).

If the detected specified instruction instructs the registration of the lesion information temporarily overlaid without modification (Step S5; YES), the controller 21 registers the lesion information temporarily overlaid without modification on the current image (Step S6). The controller 21 then shifts processing to Step S8. In Step S6, for example, the controller 21 registers the lesion information temporarily overlaid in the supplementary information on the current image appearing on the display 23. In addition, the supplementary information storing the lesion information on the current image is sent though the communication unit 24 to the image managing server 10 to update the information in the supplementary information DB 152.

If the detected specified instruction does not instruct the registration of the lesion information temporarily overlaid without modification (Step S5; NO), that is, if the detected specified instruction instructs edition of the lesion information temporarily overlaid, the controller 21 edits the lesion information temporarily overlaid according to the detected instruction, and then registers the edited lesion information on the current image (Step S7). The controller 21 then shifts processing to Step S8.

Examples of the instruction to edit the lesion information temporarily overlaid also include merging, separation, and deletion as well as positional and dimensional adjustments of an annotation described above.

The “fusion” indicates that multiple lesions captured in the past examinations as shown in FIG. 6A are combined into one lesion as shown in FIG. 6B. The merging operation involves specifying an annotation of a mergee lesion from the annotations temporarily overlaid on the current image, and specifying a merger lesion to merge the mergee lesion corresponding to the specified annotation. For example, as shown in FIG. 6B, the merging operation involves specifying the annotation of the mergee lesion (by right-clicking on the annotation, for example) with the operation unit 22 to display an edit menu in the vicinity of the annotation. The “MERGING” is selected (clicked) therefrom to display a list of the options of the lesion identifying information. One of the options of the lesion identifying information is then selected (clicked) to determine the merger lesion. The merging operation may be performed through moving and overlaying the annotation of the mergee lesion on the annotation of the merger lesion by dragging and dropping the annotation of the mergee lesion onto the annotation of the merger lesion.

In response to the merging operation described above, the controller 21 deletes the mergee lesion information corresponding to the specified annotation, adds merging information indicating the merging of the mergee lesion corresponding to the specified annotation in the merger lesion, and registers the merging information on the current image appearing on the display 23 as the lesion information. In detail, the mergee lesion information temporarily overlaid is deleted, the identifying information on the mergee lesion is added to the identifying information on the merger lesion (refer to FIG. 6C), and then the identifying information on the merger lesion is registered together with the measuring point of the merger lesion and the results of the measurement in the supplementary information on the current image appearing on the display 23. The supplementary information including the registered lesion information on the displayed current image is sent through the communication unit 24 to the image managing server 10 to update the information in the supplementary information DB 152.

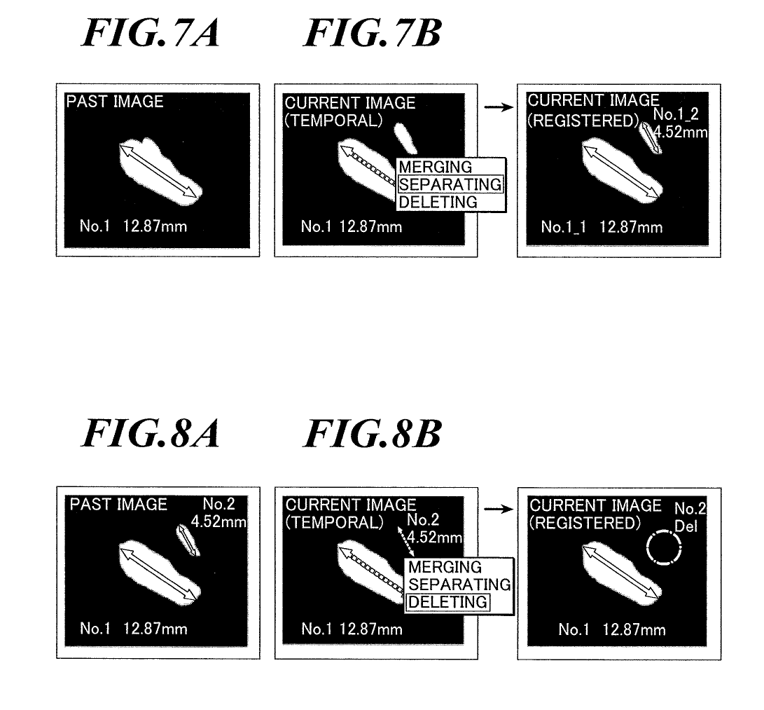

The “separation” indicates that one lesion in the past examination shown in FIG. 7A separates into multiple lesions as shown in FIG. 7. The separating operation involves specifying the annotation of a lesion to be separated from the annotations temporarily overlaid on the current image, and separating the lesion corresponding to the specified annotation. For example, as shown in FIG. 7B, the annotation on a source lesion is specified (by right-clicking on the annotation, for example) with the operation unit 22 to display the edit menu near the annotation. The “SEPARATING” is selected (clicked) therefrom to display another annotation. The other annotation is then moved onto the separated lesion and the length of the the other annotation is adjusted. Alternatively, the annotation of the source lesion may be duplicated onto the separated lesion and then the length of the duplicated annotation may be adjusted.

In response to the separating operation, the controller 21 generates another annotation of the separated lesion and the other annotation is displayed in the vicinity of the annotation of the specified source lesion. In response to a prescribed instruction to adjust the position and/or length of the annotation of the separated lesion, the controller 21 generates lesion information on the separated lesion. The controller 21 then registers the generated lesion information on the separated lesion and the lesion information on the source lesion corresponding to the specified annotation on the current image appearing on the display 23. In detail, the temporarily displayed lesion information on the source lesion is registered in the supplementary information on the current image appearing on the display 23, the lesion information on the separated lesion is generated according to the position and length of the separated lesion, and the generated lesion information is registered in the supplementary information on the current image. The identifying information on the separated lesion preferably includes the information on the source lesion (for example, as shown in FIG. 7B, the identifying information on the source lesion includes additional information indicating the separation of the lesion). The supplementary information including the registered lesion information on the current image is sent through the communication unit 24 to the image managing server 10 to update the information in the supplementary information DB 152.

The display position of the annotation of the separated lesion may be automatically determined using, for example, the region extracting algorithm described above.

The “disappearance” indicates that the lesion existing in the past examination shown in FIG. 8A disappears as shown in FIG. 8B. The deleting operation involves specifying an annotation temporarily overlaid on the current image, and registering the disappearance of the lesion corresponding to the specified annotation. For example, the temporarily displayed annotation corresponding to the disappeared lesion is specified (by right-clicking on the annotation, for example) with the operation unit 22 to display the edit menu near the annotation, and then the “DELETING” is selected (clicked) therefrom as shown in FIG. 8B. The specified annotation may be deleted by pressing the delete key, for example.

In response to the deleting operation, the controller 21 registers the information indicating the disappearance of the lesion corresponding to the specified annotation on the current image appearing on the display 23. For example, the controller 21 registers predetermined lesion information (such as “Deleted”) indicating the disappearance of the temporarily displayed lesion in the supplementary information appearing on the display 23. In addition, the supplementary information including the registered lesion information on the current image appearing on the display 23 is sent through the communication unit 24 to the image managing server 10 to update the information in the supplementary information DB 152.

Multiple (different types of) editing operations can be performed on one annotation, and accordingly the registered lesion information is updated.

In Step S8, the controller 21 determines whether an instruction to switch the images is supplied from the operation unit 22 (by pressing an arrow key or a mouse wheel, for example). If the instruction to switch the images is detected (Step S8; YES), the controller 21 switches the current image appearing on the display 23 in response to the instruction (Step S9), and then the process returns to Step S3. For the examination of one target medical image (for example, a plain radiograph), Steps S8 and S9 are omitted.

In Step S8, if no instruction to switch the images is detected (Step S8; NO), the controller 21 determines whether a prescribed instruction to indicate the completion of interpretation of the image is supplied through the operation unit 22 (Step S10). If no prescribed instruction to indicate the completion of the interpretation of the image is detected (Step S10; NO), the process returns to Step S4.

In Step S10, the prescribed instruction to indicate the completion of the interpretation of the images is detected (Step S10; YES), the controller 21 determines whether all of the lesion information acquired in Step S2 are registered (Step S11). If any of the lesion information acquired in Step S2 is not registered (Step S11; NO), the controller 21 displays a warning message, such as “Some lesions are not registered. Please register them”, on the display 23 (Step S12), and then the process returns to Step S4.

In Step S11, if the lesion information acquired in Step S2 is completely registered (Step S11; YES), the lesion information registering process is terminated.

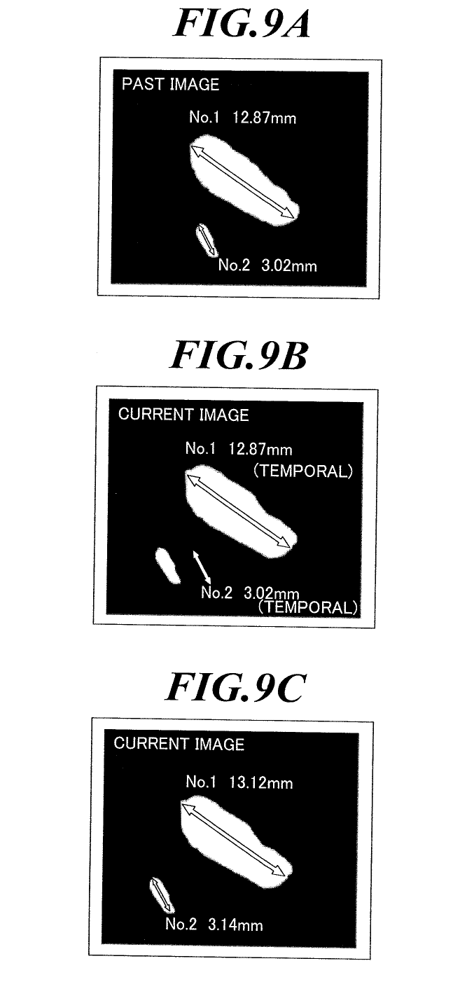

For example, FIG. 9E illustrates the current image on which the lesion information on the past image shown in FIG. 9A is overlaid. Users can compare the lesion of the current image with the temporarily overlaid lesion information on the past image, and thereby can readily determine variation in number, site, and length of the lesion, for example. In addition, the users can register the lesion information on the current image by simple operations involving adjustment of the site and/or length, without intricate operations involving specifying two points on the lesion or searching for the name of the past lesion.

As described above, the controller 21 of the client terminal 20 acquires the past lesion information found in the past images of the same object captured before the current image appearing on the display 23 was captured from the image managing server 10, and then temporarily overlays the acquired past lesion information (such as annotation) on the current image appearing on the display 23. In response to a prescribed instruction (such as double-clicking on the past lesion information) to record the past lesion information temporarily overlaid on the current image as the latest lesion information on the current image without modification from the operation unit 22, the controller 21 records the temporal lesion information without modification as the latest lesion information on the current image appearing on the display 23. In response to a prescribed instruction to edit the lesion information from the operation unit 22, the controller 21 edits the lesion information and records the edited lesion information as the latest lesion information on the medical image.

Users, therefore, can determine variation in number, site, and size of the lesion. The users can instruct to display the most similar information (for example, the identifying information and annotation of the past lesion) at a candidate lesion position on the current image to register the most similar information on the current image. This eliminates the need for additional operations to specify a lesion (such as selection of the function of drawing an annotation and selection of two points on an image) and to tag the lesion (selection of identifying information on a registered past lesion). The users can record the lesion information on the current image by simple operations involving adjustment of the position and length of the temporarily displayed sample. Even if, for example, the users find multiple candidate lesions on the image, they can determine and record the complicated variation in the lesion through a simple operation.

The descriptions in the embodiments and modifications are preferred examples of the medical image displaying system according to the present invention. The descriptions should not be construed to limit the present invention.

In the example disclosed above, the computer readable medium for the program according to the present invention is a hard disk drive, a non-volatile semiconductor memory or the like. The computer readable medium may be any drive or medium. Other examples of the computer readable medium include portable storage media, such as a CD-ROM. In addition, carrier waves (transmission waves) can also be used as a medium that provides the program according to the present invention via a communication line.

Devices included in the medical image displaying system and operations thereof may be accordingly modified without departing from the spirit of the invention.

What is claimed is:

1. A medical image displaying device comprising:
an operation unit;
a display to display a medical image of an object obtained by capturing the object;
an acquirer to acquire past lesion information on the object, the past lesion information being found in a past image of the object and being recorded in connection with the past image, the past image being obtained by capturing the object before acquiring the medical image;
a temporal displaying controller to temporarily overlay the past lesion information acquired by the acquirer on the medical image; and
a recorder, wherein the recorder records the lesion information on the medical image without modification in response to a prescribed instruction from the operation unit to record the lesion information temporarily overlaid on the medical image without modification, and the recorder edits the lesion information to record as the lesion information corresponding to the medical image in response to another prescribed instruction from the operation unit to edit the lesion information.

2. The medical image displaying device according to claim 1, wherein
the past lesion information includes identifying information on the lesion found in the past image, a measured position when a size of the lesion is measured, and results of the measurement,
the temporal displaying controller temporarily overlays the identifying information and the results of the measurement of the lesion on the medical image on the basis of the past lesion information acquired by the acquirer, and temporarily overlays an annotation indicating the measured position of the past lesion, and
the recorder records the lesion information corresponding to the annotation as the lesion information on the medical image without modification in response to a prescribed instruction from the operation unit to record the lesion information corresponding to the annotation temporarily overlaid on the medical image as the lesion information corresponding to the medical image without modification, and the recorder edits the lesion information corresponding to the annotation to record as the lesion information corresponding to the medical image in response to another prescribed instruction from the operation unit to edit the past lesion information corresponding to the annotation temporarily overlaid on the medical image.

3. The medical image displaying device according to claim 1, comprising
a determining unit determining whether there is any lesion information not recorded as the lesion information on the medical image among past lesion information acquired by the acquirer in response to a prescribed operation from the operation unit indicating a completion of the interpretation of the medical image appearing on the display, and
a warning unit to provide warning if the determining unit determines that there is lesion information which is not registered as the lesion information on the medical image.

4. The medical image displaying device according to claim 2, wherein the recorder adjusts the measured position and/or the results of the measurement in the lesion information corresponding to the annotation to record as the lesion information corresponding to the medical image in response to a prescribed instruction from the operation unit to edit a position and/or a length of the annotation temporarily overlaid on the medical image.

5. The medical image displaying device according to claim 2, wherein in response to a prescribed instruction from the operation unit to specify an annotation temporarily overlaid on the medical image and to specify a merger lesion that merges a mergee lesion corresponding to the specified annotation, the recorder deletes the lesion information on the specified annotation, adds information indicating the merge of the mergee lesion corresponding to the specified annotation to the lesion information on the merger lesion, and then records the lesion information corresponding to the medical image.

6. The medical image displaying device according to claim 2, wherein in response to a prescribed instruction from the operation unit to specify an annotation temporarily overlaid on the medical image and to separate a source lesion of the specified annotation corresponding to the specified annotation, the recorder generates another annotation for the separated lesion in the vicinity of the annotation of the specified source lesion, and in response to another prescribed instruction from the operation unit to edit the a position and/or a length of the annotation of the separated lesion, the recorder generates lesion information on the separated lesion and records the generated lesion information on the separated lesion and the lesion information on the specified annotation as the lesion information corresponding to the medical image.

7. The medical image displaying device according to claim 2, wherein in response to a prescribed instruction from the operation unit to specify an annotation temporarily overlaid on the medical image and to indicate a disappearance of the lesion corresponding to the specified annotation, the recorder records information to indicate the disappearance of the lesion corresponding to the specified annotation as the lesion information corresponding to the medical image.

8. The medical image displaying device according to claim 2, comprising
a determining unit determining whether there is any lesion information not recorded as the lesion information on the medical image among past lesion information acquired by the acquirer in response to a prescribed operation from the operation unit indicating a completion of the interpretation of the medical image appearing on the display, and
a warning unit to provide warning if the determining unit determines that there is lesion information which is not registered as the lesion information on the medical image.

9. The medical image displaying device according to claim 3, wherein in response to a prescribed instruction from the operation unit to specify an annotation temporarily overlaid on the medical image and to specify a merger lesion that merges a mergee lesion corresponding to the specified annotation, the recorder deletes the lesion information on the specified annotation, adds information indicating the merge of the mergee lesion corresponding to the specified annotation to the lesion information on the merger lesion, and then records the lesion information corresponding to the medical image.

10. The medical image displaying device according to claim 3, wherein in response to a prescribed instruction from the operation unit to specify an annotation temporarily overlaid on the medical image and to separate a source lesion of the specified annotation corresponding to the specified annotation, the recorder generates another annotation for the separated lesion in the vicinity of the annotation of the specified source lesion, and in response to another prescribed instruction from the operation unit to edit the a position and/or a length of the annotation of the separated lesion, the recorder generates lesion information on the separated lesion and records the generated lesion information on the separated lesion and the lesion information on the specified annotation as the lesion information corresponding to the medical image.

11. The medical image displaying device according to claim 3, wherein in response to a prescribed instruction from the operation unit to specify an annotation temporarily overlaid on the medical image and to indicate a disappearance of the lesion corresponding to the specified annotation, the recorder records information to indicate the disappearance of the lesion corresponding to the specified annotation as the lesion information corresponding to the medical image.

12. The medical image displaying device according to claim 3, comprising
a determining unit determining whether there is any lesion information not recorded as the lesion information on the medical image among past lesion information acquired by the acquirer in response to a prescribed operation from the operation unit indicating a completion of the interpretation of the medical image appearing on the display, and
a warning unit to provide warning if the determining unit determines that there is lesion information which is not registered as the lesion information on the medical image.

13. A non-transitory recording medium having a computer-readable program thereon, the program making a computer function as:
a display to display a medical image of an object obtained by capturing the object;
an acquirer to acquire past lesion information on the object, the past lesion information being found in a past image of the object and being recorded in connection with the past image, the past image being obtained by capturing the object before acquiring the medical image;
a temporal displaying controller to temporarily overlay the past lesion information acquired by the acquirer on the medical image; and
a recorder, wherein the recorder records the lesion information on the medical image without modification in response to a prescribed instruction from an operation unit to record the lesion information temporarily overlaid on the medical age without modification, and the recorder edits the lesion information to record as the lesion information corresponding to the medical image in response to another prescribed instruction from the operation unit to edit the lesion information.
